(19) United States
(12) Patent Application Publication
(10) Pub. No.: US 2023/0271865 A1
(43) Pub. Date: Aug. 31, 2023

(54) CLOSED-LOOP, BIOREGENERATIVE WATER PURIFICATION SYSTEMS AND METHODS

(71) Applicants: UNIVERSITY OF SOUTH FLORIDA, TAMPA, FL (US); UNITED STATES OF AMERICA AS REPRESENTED BY THE ADMINISTRATOR OF NASA, WASHINGTON, DC (US)

(72) Inventors: Daniel H. YEH, Tampa, FL (US); Melanie T. PICKETT, Tampa, FL (US); Luke ROBERSON, Orlando, FL (US); Jorge L. CALABRIA, Tampa, FL (US); Talon BULLARD, Tampa, FL (US)

(21) Appl. No.: 18/011,031

(22) PCT Filed: Jun. 21, 2021
(86) PCT No.: PCT/US2021/038280

§ 371 Date: Dec. 16, 2022

Related U.S. Application Data
(60) Provisional application No. 63/041,133, filed on Jun. 19, 2020.

(51) Int. Cl. C02F 9/00; B01D 53/22; B01D 61/14; B01D 19/00; C05F 17/40; C05F 17/971; C05F 17/80; C05F 3/04; C05F 7/00; A01G 31/00

(52) U.S. Cl. CPC C02F 9/00; A01G 31/00; B01D 19/0031; B01D 53/229; B01D 61/145; C05F 3/04; C05F 7/00; C05F 17/40; C05F 17/80; C05F 17/971; C02F 3/2853

(57) ABSTRACT

A closed-loop, bioregenerative water purification system including a gravity-independent anaerobic membrane bioreactor capable of operating in the presence and absence of gravity, the bioreactor including an anaerobic bioreactor, a first membrane filtration unit, and a second membrane filtration unit, wherein the anaerobic bioreactor is configured to receive organic waste and hygiene water as inputs and break them down into constituent components using anaerobic microbes, wherein the first membrane filtration unit is configured to receive effluent output from the anaerobic bioreactor, return concentrate to the anaerobic bioreactor, and output permeate to the second membrane filtration unit, and wherein the second membrane filtration unit is configured to receive the permeate output from the first membrane filtration unit, separate biogas from the permeate, and output nutrient-rich water.

### NOTICE OF GOVERNMENT-SPONSORED RESEARCH

This invention was made with Government support under grant contract number 80NSSC18K1692 awarded by the National Aeronautics and Space Administration (NASA), and grant contract number 1602087 awarded by the National Science Foundation (NSF). The Government has certain rights in the invention.

### CROSS-REFERENCE TO RELATED APPLICATION

This application claims priority to co-pending U.S. Provisional Application Serial Number 63/041,133, filed Jun. 19, 2020, which is hereby incorporated by reference herein in its entirety.

### BACKGROUND

Human missions to establish surface habitats on the Earth’s moon and Mars are planned in the coming decades. Extraplanetary travel and surface habitat life support systems (LSS) will require new complexity to withstand the unique challenges associated with those endeavors. In order to provide safe, habitable environments for the crew, robust and reliable water purification systems must be in place. These water purification systems will be required to treat all sources of water in order to achieve the necessary levels of recovery needed to sustain life over the long-duration missions.

Current water recovery and purification systems aboard the International Space Station (ISS) are only partially closed and, therefore, require external inputs and resupply. Furthermore, organic wastes, such as fecal and food wastes, are currently not recycled, adding additional waste processing and hazardous conditions for the crew. For long-duration missions and habitats, this is not a viable approach. The inability to recycle critical elements in organic wastes represents a lost opportunity to utilize the constituents for food production, water purification, and atmospheric regeneration. On Earth, a variety of technologies exist to meet terrestrial wastewater treatment needs, however, these systems are rarely closed-loop systems for a variety of reasons. Accordingly, new water purification systems must be developed to address the unique challenges associated with space travel and habitation.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a schematic diagram of an embodiment of a gravity-independent, closed-loop, bioregenerative water purification system.

FIG. 2 is a schematic diagram of another embodiment of a gravity-independent, closed-loop, bioregenerative water purification system.

FIGS. 3A-3C illustrate operation of an automated valve of the systems of FIGS. 1 and 2 under different gravity conditions, including: sufficient gravity (3A), insufficient gravity (3B), and sufficient gravity but in the wrong direction (3C).

### DETAILED DESCRIPTION

As described above, new water purification systems must be developed to address the unique challenges associated with space travel and habitation. Disclosed herein are examples of closed-loop, bioregenerative water purification systems and methods suitable for such applications. In some embodiments, a closed-loop, bioregenerative water purification system comprises a gravity-independent anaerobic membrane bioreactor (Gx-AnMBR) that is configured to receive organic waste, such as fecal waste, food waste, and hygiene water, and break it down to produce disinfected, nutrient-rich water that can be used for irrigation of crops cultivated in a hydroponic cultivation system. After this water is depleted of its nutrients, it can be polished using a water processor assembly to produce potable water that can be consumed by the crew. Combustible gases generated within the Gx-AnMBR can be used to produce energy to power the water treatment system, while carbon dioxide generated by the bioreactor can be provided to the hydroponic cultivation system to support photosynthesis. In some embodiments, the water treatment system further includes one or both of a nutrient dampener and a photobioreactor that regulate the concentration of nutrients within the permeate output from the bioreactor to levels that are most appropriate for the crops that are being cultivated within the hydroponic cultivation system. When included, the photobioreactor generates oxygen that can be used for crew respiration.

In the following disclosure, various specific embodiments are described. It is to be understood that those embodiments are example implementations of the disclosed inventions and that alternative embodiments are possible. Such alternative embodiments include hybrid embodiments that include features from different disclosed embodiments. All such embodiments are intended to fall within the scope of this disclosure.

As described above, current water recovery and purification systems aboard the International Space Station (ISS) are inefficient open-loop systems. As a consequence, they require external inputs that are difficult and expensive to supply. In addition, organic wastes (e.g., fecal and food wastes), which are currently not recycled, necessitate additional waste processing requirements and create hazardous conditions for crew members. This is not a viable approach for long-duration missions and extraterrestrial habitation. The inability to recycle critical elements (e.g., C, H, O, N, P, K) in organic wastes represents a lost opportunity to utilize their constituents for food production, water purification, and atmospheric regeneration. Enhanced water, elemental, and energy recovery are needed to improve the system architecture, especially to incorporate plant production in space. The 2015 National Aeronautics and Space Administration (NASA) Technology Roadmap, which serves as a guide to the development of space technologies, defines a critical need for water recovery (TA 6.1.2), waste management (TA 6.1.3), and food production systems for future habitats (TA 6.1.4), including plant production for crew dietary needs.

Proposed herein to address these needs is a gravity-independent, closed-loop, bioregenerative water purification system that integrates various novel subsystems and next-generation technologies for water purification, waste treatment, food production, and general resource recovery. The disclosed architecture includes bioregenerative aspects to create a closed-loop system in which effectively no external input is required to sustain the operation. The system is a “closed-loop” system because it captures all wastewater streams and some food waste, such as urine, wash water, humidity condensate, Sabatier water (a byproduct of a carbon dioxide removal process), fecal waste, laundry water, and organic food waste. All or some of these sources can be simultaneously fed into the system, which performs an overarching function-driven, sequential purification process. Primary functions of the system can include converting carbon as needed, generating phase separation (solid/liquid/gas), providing disinfection, managing nutrients and salts, and balancing necessary salts to generate a clean water stream suitable for human needs.

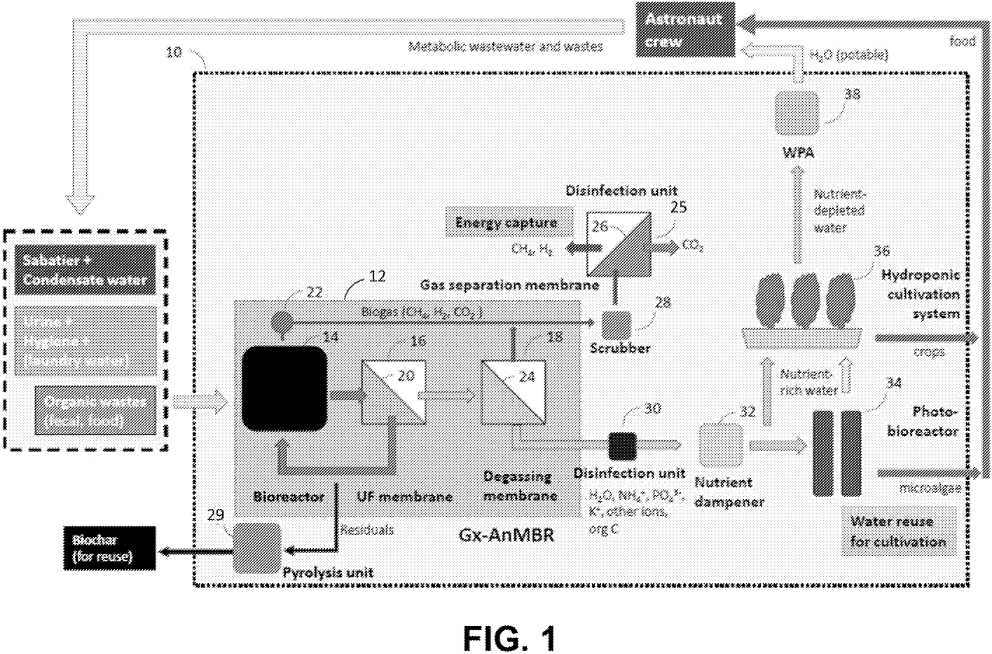

FIG. 1 is a diagram that illustrates the architecture of an example gravity-independent, closed-loop, bioregenerative water purification system 10 that is suitable for use in space, such as on a spacecraft or space station, as well as stations on extraterrestrial celestial bodies. As used herein, the term “space” refers to the expanse that exists beyond the Earth’s atmosphere. While there is no universally accepted line of demarcation as to where the Earth’s atmosphere ends and space begins, the term “space” as used herein includes the expanse that exists beyond the Kármán line (i.e., locations 100 km above Earth’s sea level).

An integral part of the bioregenerative system is the use of a bioreactor. In the context of waste treatment and resource recovery, a bioreactor is an engineered system that replicates and accelerates the natural phenomena of breaking down complex organic wastes into simpler forms, or converting chemicals from one form to another, by using microorganisms. A bioreactor contains a suspension slurry of organic wastes and microorganisms in liquid, as well as gases that evolve from the breakdown of organic matter. In an anaerobic bioreactor (or anaerobic digester), which contains a variety of anaerobic microbes, organic matter is converted to intermediate organic compounds (such as organic acids and alcohols) by acidogens and acetogens. The organic compounds eventually are converted into biogas, primarily comprising the single-carbon gas molecules methane and carbon dioxide, by methanogens.

The solid, liquid, and gaseous products of a bioreactor must be properly separated so that they can be collected and further processed or purified downstream for utilization. Simply put, the proper separation of products from the mixture is paramount to the function of a bioreactor. On Earth, where gravity is a constant, a bioreactor can be designed to utilize density (specific gravity) or buoyancy differences between phases for the separation of products. For example, gases can be collected from the bioreactor headspace and settling enables heavier solids to separate from liquids. However, in an environment where gravity is reduced or absent, fluids move in a way no longer governed by density or buoyancy. For space applications, a life support system may encounter a range of gravitational conditions. Hence, a space-appropriate bioreactor must be “gravity independent,” which, in the context of this application, means able to function regardless of the presence or absence of gravity.

The bioregenerative water purification system 10 includes various subsystems. One such subsystem is a gravity-independent anaerobic membrane bioreactor (Gx-AnMBR) 12 capable of operating in the presence or absence of gravity. Notably, an anaerobic process is used in the system 10 as anaerobic systems are more energy-efficient, do not require oxygen, produce fewer byproducts, and are more compact than aerobic systems. Therefore, anaerobic systems are more suitable for use in space applications. As shown in FIG. 1, the Gx-AnMBR 12 includes an anaerobic bioreactor 14, a first membrane filtration unit 16, and a second membrane filtration unit 18. The anaerobic bioreactor 14 comprises one or more closed vessels that contains mixture of anaerobic microbes that break down organic material that is supplied to bioreactor as inputs. These inputs include particulate and higher molecular-weight organic waste, such as fecal matter and food waste, as well as hygiene water, a waste stream from the crew’s maintenance of basic personal hygiene that can comprise constituents from skin and body secretions, rinse water, and residuals of personal care products, such as soaps and shampoo. Hygiene water is similar to what is commonly referred to as gray water on Earth. As described below, further inputs can include urine (including rinse water from urinals), humidity condensate, and Sabatier water. Additional inputs from long-duration missions or surface habitats can also include laundry water, which is similar to but more polluted than hygiene water and includes additional constituents, such as detergents.

Within the anaerobic bioreactor 14, the microbes break down the complex organic material mixture, comprised mainly of solids, into simpler constituent components, such as suspended solid particles, high-molecular weight solutes (proteins, carbohydrates, lipids, and long-chain fatty acids), low-molecular weight solutes (monomers, alcohols, and short-chain fatty acids), and inorganic solutes (ions such as ammonium, phosphate, potassium, calcium, and magnesium). These components (solids, solutes, and liquid) are output as effluent from the anaerobic bioreactor 14 and are provided to the first membrane filtration unit 16, which is a solid/liquid filtration unit including a microfiltration (MF), ultrafiltration (UF), nanofiltration (NF), or osmotic membrane 20 configured to separate the solids from the liquid. The solids, anaerobic microbes, and high-molecular weight solutes from the anaerobic bioreactor 14 are recycled back to the bioreactor as concentrate for further processing, while filtered liquid containing low-molecular weight solutes and inorganic solutes is delivered onward as permeate to the second membrane filtration unit 18.

The above-described membrane separation is gravity independent because it is achieved with or without gravity present. The MF, UF, and NF membranes are size-exclusion membranes whereby the separation is facilitated by a trans-membrane pressure (TMP) difference between feed (upstream) and permeate (downstream) sides of the membrane. The TMP is created by one or more pumps creating feed-side positive pressure or permeate-side negative pressure, or both. In the case of the osmotic membrane, the liquid is drawn across the membrane through a chemical potential difference between the feed and permeate sides. For example, a draw solution on the permeate side that contains a high number of ions “pulls” feed-side liquid that contains fewer ions across the membrane due to the chemical potential energy across the membrane. Optionally, in some embodiments, the filtration unit 16 can be placed within the bioreactor 14 rather than being external to it.

In the presence of gravity, such as on Earth (1G), the Moon (0.17G), or Mars (0.38G), the biogas produced as a byproduct of the reactions that occur within the anaerobic bioreactor 14 naturally rises to the headspace of the bioreactor due to fluid density difference and can be easily extracted as a singular-phase gas, while the liquid and solid contents remain in the bioreactor. However, in space, due to the absence of gravity and the lack of a defined headspace within the reactor, at least some of the liquid and solids may travel up the gas collection line. This may cause problems with clogging and contamination of downstream gas collection and processing assembly. To prevent this from occurring, it is desirable for the bioreactor to function properly irrespective of the presence or absence of gravity.

In some embodiments, the problem is solved with the use of an automated valve 22 that is configured to respond to gravity conditions. One such example is an electronic solenoid valve, which receives signals from one or more gravity sensors. Examples of such gravity sensors include tilt sensors, accelerometers, and/or gyroscopes, which are often used in smart phones, tablets, or other mobile devices. In addition to the magnitude of the gravitational force, the direction of gravity can also be determined through the use of a combination of sensors or a triaxial (X, Y, and Z) sensor. When sufficient gravity is detected and is directed toward the bottom of the bioreactor (as is the normal case on Earth), the reactor headspace is filled with biogas and the valve 22 automatically opens to enable venting and collection of biogas through fluid buoyancy. When gravity is insufficient for such venting (e.g., gravity is absent, too small in magnitude, unstable, or inconsistent) the valve closes. During this time, the second membrane module 18 is used to separate gas and liquid.

The threshold value between opening and closing of the valve 22 can be adjusted based on the specific bioreactor type, configuration, and geometries, or based on mission requirements. In some embodiments, a value of 0.05 G (1/20) of the Earth’s gravity, can be used as a suitable threshold. In addition to the aforementioned electronically controlled solenoid valve, other examples of automated valves include entirely mechanical valves. One such mechanical valve comprises a spring-loaded mechanism that closes the valve and a counterweight that keeps the valve open under sufficient gravity in the direction of the bottom of the reactor (as is the normal case on Earth). When gravity is insufficient for venting, however, the counterweight no longer exerts sufficient force to keep the valve open, and the valve closes due to the force applied by the spring-loaded mechanism. The balance of the spring and counterweight can be specifically tailored for different reactor applications and missions.

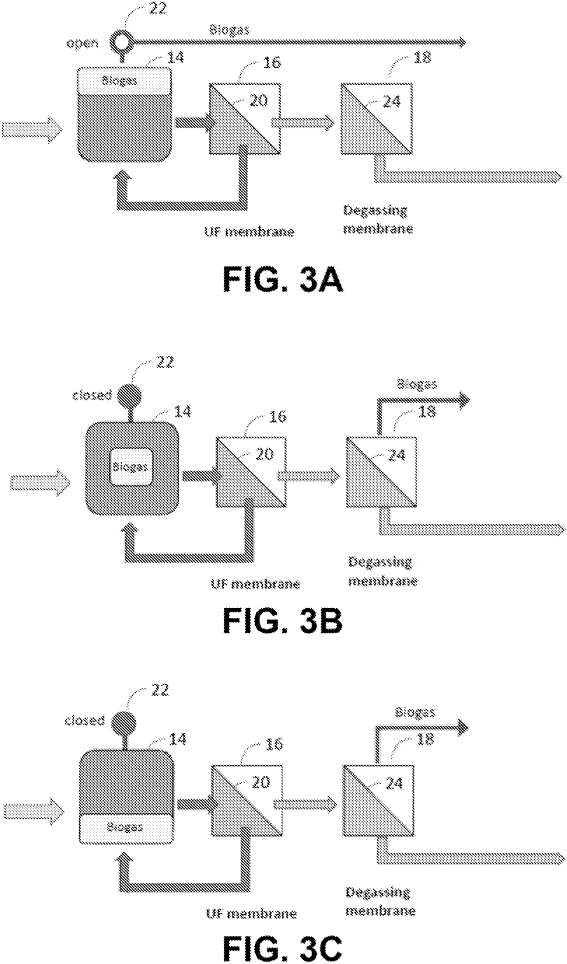

FIGS. 3A-3B illustrate operation of the automated valve 22 in three different cases. FIG. 3A illustrates a case in which there is sufficient gravity to vent biogas directly from the anaerobic bioreactor 14. In such a case, the valve 22 automatically opens and biogas exits the headspace of the anaerobic bioreactor 14 via the valve. In FIG. 3B, gravity is insufficient to vent biogas directly from the anaerobic bioreactor 14 so the valve 22 stays closed. In this case, the biogas is delivered along with the effluent output from the bioreactor 14 to the first membrane filtration unit 16. The first membrane filtration unit 16 then outputs permeate that contains biogas, and the permeate is delivered to the second membrane filtration unit 18, which separates the biogas from the permeate. In FIG. 3C, although gravity is sufficient to vent biogas directly from the anaerobic bioreactor 14, the bioreactor is in an orientation in which the valve 22 is not positioned above the anaerobic bioreactor 14 (in terms of the direction of gravity). For example, the anaerobic bioreactor 14 may be inverted, in which case the biogas would collect at the bottom of the bioreactor instead of the headspace at the top of the bioreactor. In such a case, the valve 22 also stays closed and the biogas is also separated from the permeate by the second membrane filtration unit 18.

The second membrane filtration unit 18 is a gas/liquid filtration unit that includes a membrane 24 that is configured to separate dissolved and bubble gas from the liquid in a degassing process. In some embodiments, the membrane is a silicon rubber elastomer (phenyl vinyl methyl siloxane (PMVQ), vinyl methyl siloxane (MVQ), or polydimethylsiloxane PDMS)) membrane, a hydrophobic membrane (e.g., polytetrafluoroethylene (PTFE)), or a composite membrane comprising layers of porous (e.g., polyurethane) and nonporous membranes (polyethylene or polypropylene). Irrespective of its configuration, the membrane 24 enables dissolved gas molecules to pass through the membrane but prevents water or solutes from doing so. In other embodiments, the membrane 24 is a microporous hollow-fiber membrane module, which maximizes surface area for gas transfer.

The second membrane filtration unit 18, which is not used in terrestrial AnMBRs, is required because of the potential for insufficient-gravity (zero-, micro-, or unsteady-gravity) environments. Due to such conditions, the lack of a defined headspace in the reactor, and the operation of the valve 22, at least some of the biogas is likely to be mixed in with the liquid permeate exiting the first membrane filtration unit 16. The unpredictable mixing of the gas and liquid presents challenges for the processing, storage, and utilization of these resources downstream. For example, gas bubbles can interfere with the metering and flow of liquids in small-diameter pipes. Furthermore, unremoved biogas may inadvertently enter the crew cabin space. This problem is solved by the use of the second membrane filtration unit 18, which separates this biogas from the liquid so that both of these streams can be individually processed and utilized. In some embodiments, the filtration unit 18 can be placed within the bioreactor 14, rather than being external to it. Although the second membrane filtration unit 24 is anticipated to operate primarily during an insufficient-gravity mode, it can also operate during a sufficient-gravity mode as an additional safeguard to separate gaseous and liquid products.

It should be noted that the gravity-independent approach described above is not limited to anaerobic methanogenic systems that produce biogas. In fact, the approach can be applied to any bioreactor system that generates excess gas, which is ordinarily easily separated from the liquid via the headspace of the bioreactor due to gravity in sufficient-gravity settings, such as on planetary surface or under artificial gravity. Examples of bioreactor types and the corresponding excess gases include aerobic carbon dioxide (CO₂), anoxic nitrogen (N₂), anaerobic sulfate-reducing hydrogen sulfide (H₂S), and phototrophic oxygen (O₂).

The biogas produced within the anaerobic bioreactor 14 primarily comprises methane, hydrogen, and carbon dioxide. The methane and hydrogen gas can be utilized as fuel for combustion and, therefore, the production of energy that can be used to operate the bioregenerative water purification system 10 or other systems or components. In addition or in the alternative, the hydrogen gas can be combined with oxygen in a Sabatier process to produce potable water. As described below, the carbon dioxide, which is typically considered to be a waste product, can be utilized within the system 10 to facilitate the growth of microalgae and crops.

In view of its potential usefulness, the biogas produced by the Gx-AnMBR 12 can be captured and stored for later use. Specifically, biogas is extracted from the headspace of the anaerobic bioreactor 14 when gravity is sufficient and from the second membrane filtration unit 18 when gravity is insufficient. The biogas is then delivered to a third membrane filtration unit 24 that is configured as a gas/gas filtration unit including a membrane 26 configured to separate the different types of gases within stream from each other. Membranes capable of separating gas mixtures include polyimide (PI), polysulfone (PS), polycarbonate (PC), and thermally-arranged (TA) membranes. In some embodiments, the membrane is a mixed-matrix membrane containing zeolite incorporated into a polysulfone membrane.

In some embodiments, the membrane 26 of the third membrane filtration unit 24 is a molecular sieve containing a polymeric matrix having a filler, such as a metal-organic framework (MOF), which contains nanoscale pores. For example, the third membrane filtration unit 24 can separate the combustible gases (methane, hydrogen) from the carbon dioxide, and each of these gases can be utilized in the desired applications. Optionally, a scrubber 28 can be provided upstream of the third membrane filtration unit 24 to remove impurities from the biogas, such as trace quantities of water vapor, hydrogen sulfide, ammonia (NH3), siloxane ([—Si—O—], N₂, CO₂, and volatile organic acids. Examples of scrubbers include packed iron wool, water scrubbers, and pressure swing absorption (PSA) scrubbers. The removed impurities can, for example, be vented to space.

It is also noted that small quantities of accumulated undigested solid matter (residual material) from within the anaerobic bioreactor 14 can be converted into biochar by a pyrolysis unit 29 and used as activated carbon for water or air purification or as a plant growth medium. The residual material can be removed either periodically during maintenance cycles from a valve connected to the bioreactor 14 or on a continuous slow bleed through a valve connected to the concentrate line of membrane module 16.

With further reference to FIG. 1, permeate output from the Gx-AnMBR 12 (i.e., from the second membrane filtration unit 18) can be used to cultivate crops and, ultimately, to produce potable water, using other subsystems of the water treatment system 10. The permeate includes various nutrients, such as ammonium (NH₄), phosphate (PO₄³⁻), potassium (K⁺), and other ions, which can be used as fertilizer for the crops. The National Aeronautics and Space Administration (NASA) has estimated that approximately 93 kg per crew member per year of fertilizer must be supplied to produce crops in space as organic materials are not recycled to produce such nutrients. This involves substantial cost and effort. By using the nutrients produced by the Gx-AnMBR 12 as fertilizer, however, the amount of fertilizer that must be supplied to a spacecraft, space station, or surface colony can be significantly reduced. By way of example, the amount of fertilizer can be reduced by 50% or more.

Although the Gx-AnMBR 12 sanitizes the organic material that it receives, it is still possible that organic carbon and nutrients present within the permeate output from the Gx-AnMBR can promote microbial growth downstream. Accordingly, the bioregenerative water purification system 10 can include a water disinfection unit 30 configured to kill or inactivate pathogenic bacteria, protozoans, and viruses that may still be within the permeate. In some embodiments, the water disinfection unit 30 uses one or more ultraviolet (UV) light-emitting diodes (LEDs), which have low energy demand. In other embodiments, the water disinfection unit 30 uses ozone, which both disinfects and “polishes” the water by removing residual organic matter.

In some cases, the permeate output from the GxAnMBR 12 may have too high of a concentration of nutrients for use in cultivating certain crops. For example, higher order plants may not tolerate relatively high concentrations of ammonium. The concentration of nutrients within the permeate can be regulated to more beneficial levels using one or both of a nutrient dampener 32 and a photobioreactor 34, which each can comprise a subsystem of the bioregenerative water purification system 10.

In some embodiments, the nutrient dampener 32 is configured to reduce the NH₄⁺ concentration of the permeate through nutrient adsorption. For example, the nutrient dampener 32 can comprise one or more reusable nutrient cartridges that contain a nutrient adsorption material, such as zeolitic materials (zeolites), that can be “charged” with nutrients by flowing the permeate through the cartridge. Once the cartridge has been appropriately charged with nutrients, it can be removed from the permeate flow path and replaced by a new or depleted cartridge. The charged cartridge can then be used as needed to supply nutrients to an application in which they are required, such as cultivation of one or more crops. This can be accomplished by simply flowing fresh water through the cartridge and out onto the crops. Example embodiments of such a cartridge system are provided in International Patent Publication Number 2018/017975, entitled “Systems and Methods for Nutrient Recovery and Use,” which is hereby incorporated by reference in its entirety into the present disclosure.

The water that exits the nutrient dampener 32 can be directly delivered to a hydroponic cultivation system 36 (another subsystem of the bioregenerative water purification system 10) for use in irrigating crops to be cultivated for human and/or animal consumption. Additionally or alternatively, this water can be provided to the photobioreactor 34 for further nutrient regulation. In some embodiments, the photobioreactor 34 can be used to cultivate microalgae. This cultivation converts nutrients remaining in the water into algal biomass, thereby naturally reducing the water’s nutrient concentration. In addition, microalgae cultivation may convert ammonium nitrogen into nitrate nitrogen, which may be preferable for crop cultivation. In some embodiments, the photobioreactor 34 comprises a photo membrane bioreactor (PMBR). Similar to the Gx-AnMBR 12, a PMBR is capable of operating independently of gravity by using a set of liquid/solid membranes that separates algal cells from liquid, and a set of gas/liquid membranes within the bioreactor that delivers CO₂ to the algal cells and removes oxygen from the system. In some embodiments, a gravity-sensing valve can be utilized in the PMBR.

In addition to growing microalgae and reducing nutrient concentration, the photobioreactor 34 also produces oxygen and sequesters carbon dioxide generated by the Gx-AnMBR 12 and from crew respiration. Oxygen is a valuable byproduct of the photobioreactor 34 that can contribute to achieving suitable atmospheric conditions needed for crew safety. The harvested microalgae also has a variety of potential end uses, including use as influent for the Gx-AnMBR 12 for enhanced methane biogas production, plant fertilizer, feed for an optional oyster/mollusk water purification subsystem, and crew dietary supplement. In addition, harvested microalgae can be used to create pharmaceuticals, nutraceuticals, fuel, or bioplastics. While both the nutrient dampener 32 and the photobioreactor 34 are illustrated in FIG. 1 and have been described herein, it is noted that that they are optional and the bioregenerative water purification system 10 can include one, both, or neither of them, depending upon the particular application.

Reduced-nutrient water from the nutrient dampener 32, the photobioreactor 34, or both can be provided to the hydroponic cultivation system 36 for purposes of crop cultivation. Examples of crops that can be grown using the cultivation system 36 include lettuce, tomato, cucumber, peppers, Swiss chard, and herbs such as basil. The cultivation system 36 recovers and utilizes the nutrients in the water (and/or provided by a nutrient cartridge), such as nitrate and ammonium. In some embodiments, a 2:1 ratio of nitrate to ammonium may be preferred, although the ratio may be varied to suit the particular crops that are being cultivated. Edible plants grown within the cultivation system 36 can be consumed by the crew while any non-edible biomass can be fed back to the Gx-AnMBR 12.

Effluent water from the hydroponic cultivation system 36 is largely devoid of nutrients and salts and, therefore, can be directly delivered to a water processor assembly (WPA) 38 (another subsystem of the bioregenerative water purification system 10) for polishing so as to produce potable water. This final polishing combines multiple steps to accomplish the three main objectives of deionization (DI), decarbonization (DC), and disinfection (Dis), and uses processes such as capacitive deionization (DI), ion exchange (DI), multi- and mixed-media filtration (DI, DC, Dis), nanofiltration (DI, DC, Dis), reverse osmosis filtration (DI, DC, Dis), activated carbon (DI, DC), distillation (DI, DC), ozone (DC, Dis), and UV (Dis) processes. The potable water output from the WPA 38 can be consumed by the crew and the urine the crew produces as a consequence of that consumption can also be used as an input to the bioregenerative water purification system 10.

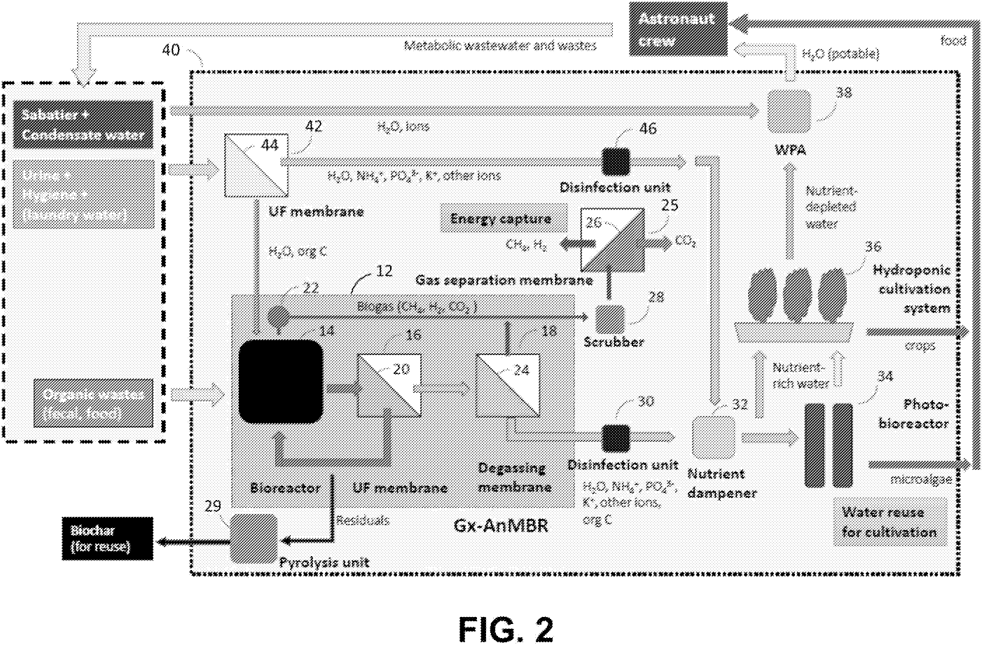

FIG. 2 illustrates a further embodiment of a gravity-independent, closed-loop, bioregenerative water purification system 40 similar to that shown in FIG. 1. In this embodiment, however, urine water, rinse water, hygiene water, and laundry water can be processed with an optional fourth membrane filtration unit 42. The filtration unit 42, when provided, is a liquid-liquid filtration unit including an ultrafiltration membrane 44 that separates higher molecular weight materials, such as organic carbon (C) from the urine, rinse, hygiene, and laundry water and delivers them to the anaerobic bioreactor 14 of the Gx-AnMBR 12. While those types of water can, in some embodiments, be provided directly to the anaerobic bioreactor 14, providing too much water to the bioreactor may result in a diluted waste stream that reduces the bioreactor’s efficiency. Therefore, some of the water, as well as other components within the urine and hygiene water streams, such as NH4⁺, PO₄³⁻, potassium (K⁺), and other ions, can be diverted and supplied to the nutrient dampener 30 for use in moderating the nutrient concentration of the Gx-AnMBR permeate. As with that permeate, the permeate output from the fourth membrane filtration unit 42 can be purified using a water disinfection unit 46 prior to it reaching the nutrient dampener 32.

Water streams from the Sabatier and condensate processes are relatively cleaner in terms of organic matter, ions, and pathogens and, if needed, can be fed as dilution water either to the Gx-AnMBR 12 or any of the downstream treatment subsystems, such as the nutrient dampener 32, photobioreactor 34, or hydroponic cultivation system 36. Alternatively, these two streams can be fed directly into the WPA 38, bypassing the rest of the bioregenerative water purification system 40, as shown in FIG. 2.

The above-described closed-loop, bioregenerative water purification systems provide numerous advantages over the open-loop, non-regenerative water purification systems currently used in space, such as on the ISS. First, as the systems 10 are closed-loop and bioregenerative, they do not require external inputs and utilizes nearly all the waste produced by the crew and converts it into nutrient-rich water that can be used to cultivate edible crops. Not only does this process utilize organic waste that is currently discarded, it further greatly reduces the amount of fertilizer that must be supplied at high cost and unnecessary risk. The effluent from the crop cultivation can then be polished to produce potable water.

In addition, the disclosed bioregenerative water purification systems produce biogas that can be separated into distinct gas streams that can be utilized for various beneficial end uses. For example, combustible gases produced by the systems can be used to generate the energy needed to operate the system (e.g., to power pumps that drive fluids through the system). Oxygen is also produced that can supplied to the crew for respiration. Additionally, carbon dioxide is produced that can be used to facilitate microalgae and/or crop cultivation.

Beyond those benefits, the disclosed bioregenerative water purification systems also facilitate a fundamental shift from chemical-based processing to biological-based processing. This shift is significant as the chemical processing currently performed on the ISS and other spacecraft requires aggressive chemicals, such as oxidants and heavy metals, which must be carefully supplied and managed. Furthermore, the biological processes of the disclosed systems can be performed at temperatures and pressures that are close to ambient conditions within the spacecraft or space station, instead of the high temperatures and pressures required by existing systems. Not only do those high temperatures and pressures require greater input energy to achieve, they further pose serious risks to the safety of the crew.

Claimed are:

1. A closed-loop, bioregenerative water purification system comprising:
a gravity-independent anaerobic membrane bioreactor capable of operating in the presence and absence of gravity, the bioreactor including an anaerobic bioreactor, a first membrane filtration unit, and a second membrane filtration unit, wherein the anaerobic bioreactor is configured to receive organic waste and hygiene water as inputs and break them down into constituent components using anaerobic microbes, wherein the first membrane filtration unit is configured to receive effluent output from the anaerobic bioreactor, return concentrate to the anaerobic bioreactor, and output permeate to the second membrane filtration unit, and wherein the second membrane filtration unit is configured to receive the permeate output from the first membrane filtration unit, separate biogas from the permeate, and output nutrient-rich water.

2. The water purification system of claim 1, wherein the first membrane filtration unit includes a microfiltration, ultrafiltration, nanofiltration, or osmotic membrane configured to separate solids from liquid.

3. The water purification system of claim 1, wherein the second membrane filtration unit includes a membrane configured to separate gases from liquid.

4. The water purification system of claim 3, wherein the membrane comprises one or more of a silicon rubber elastomer, hydrophobic, composite, or microporous hollow-fiber membrane.

5. The water purification system of claim 1, further comprising an automated valve associated with the gravity-independent anaerobic bioreactor through which biogas produced in the bioreactor can be vented, wherein the valve is configured to automatically open or close depending upon gravity conditions.

6. The water purification system of claim 5, wherein the automated valve is configured to open if a gravitational force acting on the valve is equal to or greater than approximately 0.05 G.

7. The water purification system of claim 5, wherein the automated valve is an electronic solenoid valve that automatically opens or closes depending upon the gravity conditions sensed by one or more sensors.

8. The water purification system of claim 5, wherein the automated valve is an entirely mechanical valve that automatically opens or closes depending upon the gravity conditions.

9. The water purification system of claim 1, further comprising a hydroponic cultivation system configured to cultivate crops using nutrient-rich water output from the gravity-independent anaerobic membrane bioreactor.

10. The water purification system of claim 9, further comprising a water disinfection unit configured to kill or inactivate pathogens in the nutrient-rich water prior to it being provided to the hydroponic cultivation system.

11. The water purification system of claim 9, further comprising a nutrient dampener configured to reduce a concentration of nutrients within the nutrient-rich water prior to it being provided to the hydroponic cultivation system.

12. The water purification system of claim 9, further comprising a water processor assembly configured to polish effluent water output from the hydroponic cultivation system and produce potable water.

13. The water purification system of claim 1, further comprising a photobioreactor configured to cultivate microalgae and reduce the concentration of nutrients within nutrient-rich water output from the gravity-independent anaerobic membrane bioreactor.

14. The water purification system of claim 1, further comprising a third membrane filtration unit configured to receive biogas from the anaerobic bioreactor and the second membrane filtration unit and separate the biogas into different gas streams.

15. The water purification system of claim 14, further comprising a scrubber configured to remove impurities from the biogas before it is provided to the third membrane filtration unit.

16. The water purification system of claim 14, further comprising a fourth membrane filtration unit configured to receive urine, rinse, hygiene, and laundry water and separate organic materials from liquid within the water, wherein the organic materials are input into the anaerobic bioreactor and the liquid is added to the nutrient-rich water output from the gravity-independent anaerobic membrane bioreactor.

17. The water purification system of claim 16, further comprising a water disinfection unit configured to kill or inactivate pathogens in the liquid from the fourth membrane filtration unit before the liquid is added to the nutrient-rich water.

18. A method of purifying water, the method comprising:
providing organic waste and hygiene water to an anaerobic bioreactor and breaking down organic material within the bioreactor using anaerobic microbes;
outputting effluent from the anaerobic bioreactor and separating solids from liquid in the effluent with a first membrane filtration unit;
outputting concentrate and permeate from the first membrane filtration unit, wherein the concentrate is returned to the anaerobic bioreactor and the permeate is provided to a third membrane filtration unit;
separating biogas from liquid of the permeate with the third membrane filtration unit; and
outputting nutrient-rich water from the second membrane filtration unit.

19. The method of claim 18, further comprising venting biogas from the anaerobic bioreactor using an automated valve configured to automatically open or close depending upon gravity conditions.

20. The method of claim 18, further comprising delivering the nutrient-rich water to a hydroponic cultivation system and growing a crop with the system.
